(19) United States
(12) Patent Application Publication
(10) Pub. No.: US 2022/0304327 A1
(43) Pub. Date: Sep. 29, 2022

(54) Tempered Chocolate Depositing Device

(71) Applicant: Daniel Fairbank, Sudbury, MA (US)

(72) Inventor: Daniel Fairbank, Sudbury, MA (US)

(21) Appl. No.: 17/704,119

(22) Filed: Mar. 25, 2022

Related U.S. Application Data
(60) Provisional application No. 63/167,095, filed on Mar. 28, 2021.

(51) Int. Cl. A23G 1/20

(52) U.S. Cl. CPC A23G 1/206; H05B 2203/007; H05B 2203/016

(57) ABSTRACT

A tempered chocolate deposition device is disclosed herein. While the present disclosure can be advantageously used for the accurate deposition of chocolate from a chocolate tempering machine, it may also be used with other liquid material. Liquid chocolate-like mass may leave the tempering machine through its tempering machine output nozzle. A tempered chocolate deposition device constructed according to the present disclosure may be sized to engage with the output nozzles of an OEM tempering machine having varying sizes, shapes, or geometries.

### BACKGROUND

### Technical Field

The present disclosure relates generally to a tempered chocolate depositing device. More particularly the present disclosure relates to a device that uniformly deposits liquid chocolate into an open-faced mold having one or more cavities.

### Description of Related Art

The present disclosure concerns the manufacture of an accessory for depositing tempered liquid chocolate for an original equipment manufacturer (“OEM”) tempering machine.

There is among the chocolate making industry a subset of chocolate manufacturers who can be considered craft chocolate makers. These craft chocolate makers use tempering.

machines whose single batch capacities are typically less than or equal to 100 kg of chocolate-like mass. Small machines of this nature are used because the volume of production is relatively low (i.e., less than or equal to 2000 bars per day). However, this level of production is a significant step up from tabletop tempering machines. Machines of this nature represent a cost-effective method and economical step-up for producing chocolate-like confections.

In particular, these chocolate tempering machines will have a heated bowl or basin that is used to turn solid chocolate into and to maintain liquid chocolate. The bowl is connected internally (as part of the tempering machine) to a system or mechanism that cycles chocolate through a tempering stage. Typically, while in the tempering phase, chocolate is continuously cycled from the heated chocolate bowl through the tempering phase mechanism, out a single nozzle or spout, and returns freely to the heated bowl. It is during this tempering phase that the craft chocolate maker can use the liquid chocolate to make any variety of chocolate confections, Typically, applications include chocolate covered confections, bon-bons and chocolate bars.

There currently exist in the market a variety of OEM tempering machines. Each tempering machine has a slightly different output nozzle for flowing liquid chocolate back into the heated basin, or for use in depositing chocolate into the chocolate molding medium. Among the craft chocolate making industry there is a subset of manufactures that focus a large part of their industry on the production of chocolate bars. While this is not their sole focus on the production of chocolate confections, it represents a large portion of their industry.

The production of chocolate bars on this scale is generally done using open faced plastic molds. The open-faced plastic molds are filled from the output nozzle of the tempering machine. Typically, the tempering machines will have a function that pauses the continuous flow of chocolate from the output nozzle. This pause allows the chocolatier to position the open-faced mold below the output nozzle. This process only allows the chocolatier to fill one cavity at a time. Typical open-faced molds have greater than 3 bar cavities per pan or sheet.

Prior art has addressed the inefficiency of filling one cavity per pause by creating an accessory that attaches directly to the output nozzle or orifice of the tempering machine. This accessory is commonly referred to by many different names, including but not limited to, an injection plate, a dosing plate, or a dosing unit. However, the prior art does not specifically control the rate of flow of each nozzle on the depositing head. Chocolate leaves the tempering cycle output nozzle and enters the deposition device. Once the chocolate enters the deposition device, a relatively large cavity is flooded with chocolate. By way of the least path of resistance, the liquid chocolate floras to the numerous deposition devices output nozzles.

Examples of prior art have attempted to control the flow rate of each nozzle by using various forms of non-integral internal filters or baffles. However, the volume of chocolate that leaves each nozzle at a specific interval is non-uniform because these examples of prior art do not actively control the flow path of the liquid chocolate. Due to this issue, the weight of the bars will have considerable variation. Variation in the chocolate bar weight will result in either: (1) excessive chocolate mass in each bar resulting. in large volumes of chocolate wasted each year; (2) inadequate bar weight, exposing end users of such prior art devices to FDA violations; or (3) loss of goodwill with customers for under advertised weights.

There are numerous other problems with examples of prior art to which there are a seemingly infinite amount of potential solutions. Therefore, what is needed is a tempered chocolate depositing device having the following characteristics and benefits over the prior art.

### SUMMARY

The subject matter of this application may involve, in some cases, interrelated products, alternative solutions to a particular problem, and/or a plurality of different uses of a single system or article.

In aspect, a liquid deposition device disclosed. In this aspect, the liquid deposition device comprises an adaptor plate, a top plate, and a channel plate. The adaptor plate, the top plate, and the channel plate are secured together by a first threaded knob, and the adaptor plate defines an input orifice for receiving liquid, and the top plate defines an output orifice for expelling liquid.

In another aspect, a method for making and using a liquid chocolate deposition device is disclosed. In this aspect the method comprises the steps of: providing the liquid chocolate deposition device, loosening the first threaded knob, removing the adaptor plate, placing an in-line filter on a filter seat defined on a top of the top plate, placing the adaptor plate on the top of the top plate having the in-line filter, and, finally, tightening the first threaded knob

It should be expressly understood that the various physical elements of the present disclosure summarized and further disclosed herein may be of varying sizes, shapes, or otherwise dimensions and made from a variety of different materials or methods of manufacture without straying from the scope of the present disclosure.

### BRIEF DESCRIPTION OF THE DRAWINGS

FIG. 1 is a perspective view of one embodiment of the assembly of the tempered chocolate deposition device with a heating plate assembly installed.

FIG. 2 is a cross-sectional view of one embodiment of the assembly of the tempered chocolate deposition device with the heating plate assembly installed.

FIG. 3 is a perspective view of one embodiment of an adaptor plate for the tempered chocolate deposition device.

FIG. 4 is a perspective view of one embodiment of the an filter for the tempered chocolate deposition device.

FIG. 5 is a perspective view of one embodiment of the top side features of the top plate for the tempered chocolate deposition device.

FIG. 6 is a perspective view of one embodiment of the bottom side features of a top plate for the tempered chocolate deposition device.

FIG. 7 is a perspective view of one embodiment of the top side features of the channel plate for the tempered chocolate deposition device.

FIG. 8 is a perspective view of another embodiment of the bottom side features of a channel plate for the tempered chocolate deposition device.

FIG. 9 is a perspective view of another embodiment of the top side features of the channel plate for the tempered chocolate deposition device providing greater detail of the channels.

FIG. 10 is a perspective view of a three bar open-faced mold.

FIG. 11 is a cross-sectional view of one embodiment of a scallop or nozzle of the channel plate for the tempered chocolate deposition device providing greater detail of the top side features for the channel plate.

FIG. 12 is a perspective view of one embodiment of a mold holder for the tempered chocolate deposition device.

FIG. 13 is a cross-sectional view of an embodiment of the top side of the tempered chocolate deposition device having a heating plate assembly attached.

FIG. 14 is a perspective view of one embodiment of a heating plate body for the tempered chocolate deposition device.

FIG. 15 is a perspective view of one embodiment of heating plate cover for the tempered chocolate deposition device.

FIG. 16 is a semi-cross-sectional perspective view of one embodiment of temperature controller for the tempered chocolate deposition device.

### DETAILED DESCRIPTION

The detailed description set forth below in connection with the appended drawings is intended as a description of presently preferred embodiments of the invention and does not represent the only forms in which the present disclosure may be constructed and/or utilized. The description sets forth the functions and the sequence of steps for constructing and operating the invention in connection with the illustrated embodiments.

Generally, the present disclosure concerns a tempered chocolate deposition device. While the present disclosure can be advantageously used for the accurate deposition of chocolate from a chocolate tempering machine, it may also be used with other liquid material. Accordingly, unless otherwise indicated, there is no intention to limit the present disclosure to merely the deposition of chocolate or chocolate-like masses. Liquid chocolate-like mass may leave the tempering machine through its tempering machine output nozzle. A tempered chocolate deposition device constructed according. to the present disclosure may be sized to engage with the output nozzles of an OEM tempering machine having varying sizes, shapes, or geometries. In most embodiments, most corners of the present disclosure should either have controlled chamfers or controlled radii. These features should be used to mitigate injury to the end user of the device from sharp corners. Additionally, while the present disclosure is not limited to a particular material, in some embodiments, commercially available heat-treated aluminum may be used. Tn other embodiments, it may be desirable to hard anodize a particular part or component of the device. In yet other embodiments, solid metallic alloys may be used as raw material, and, preferably, any metallic alloy having corrosion. resistance or wear resistance may be used. The primary objective of the illustrated embodiments described below is to provide a chocolate deposition device that precisely controls the flow rate of liquid chocolate flowing from an OEM tempering machines output nozzles and through the deposition. device disclosed herein.

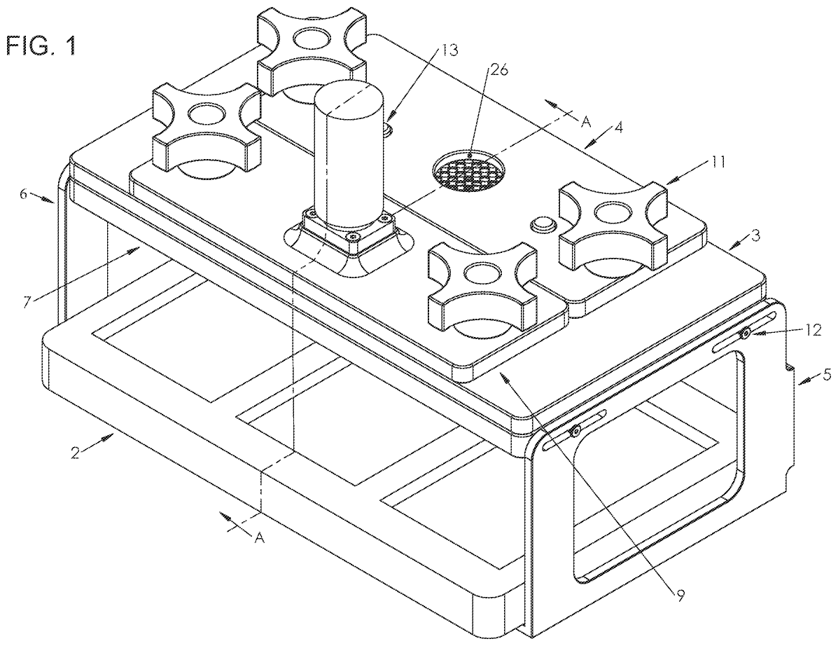

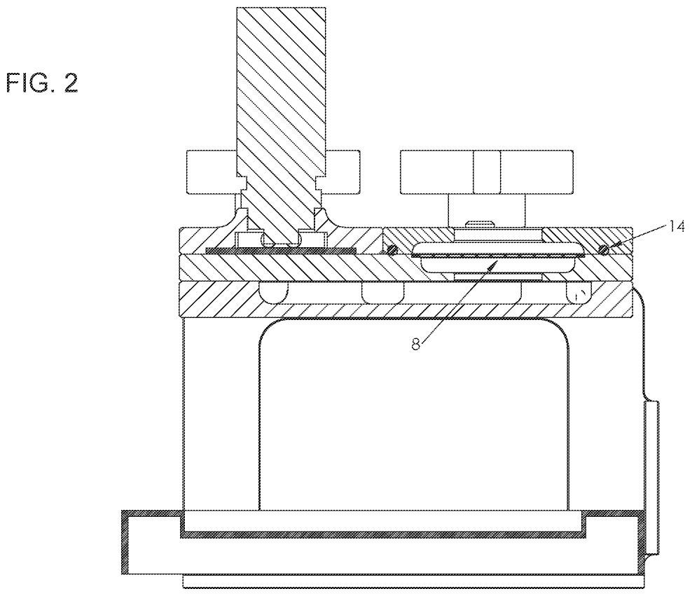

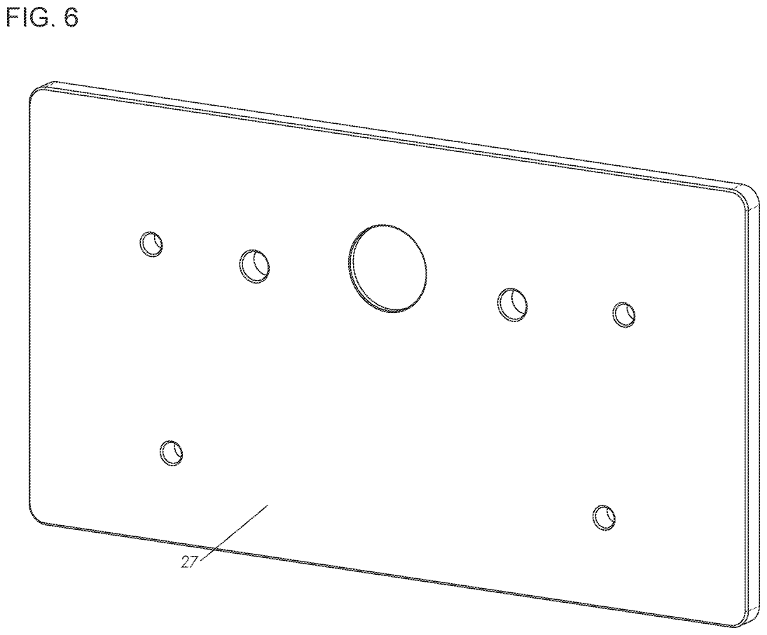

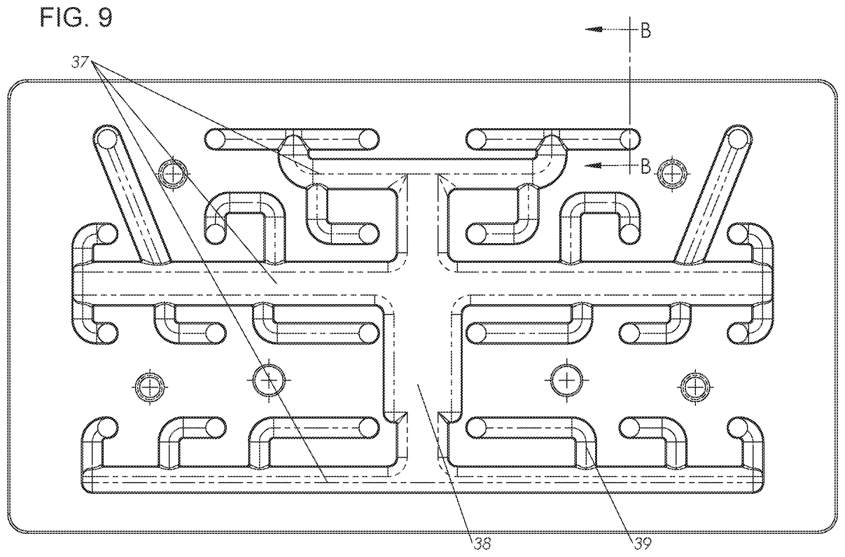

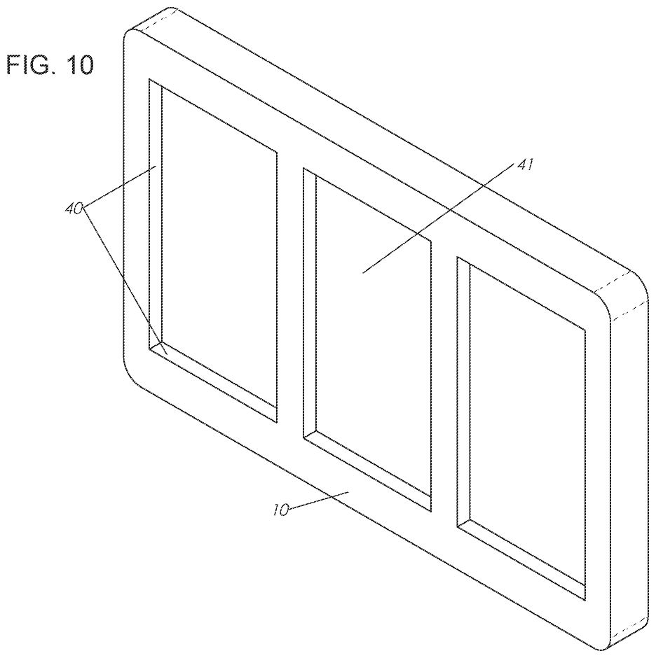

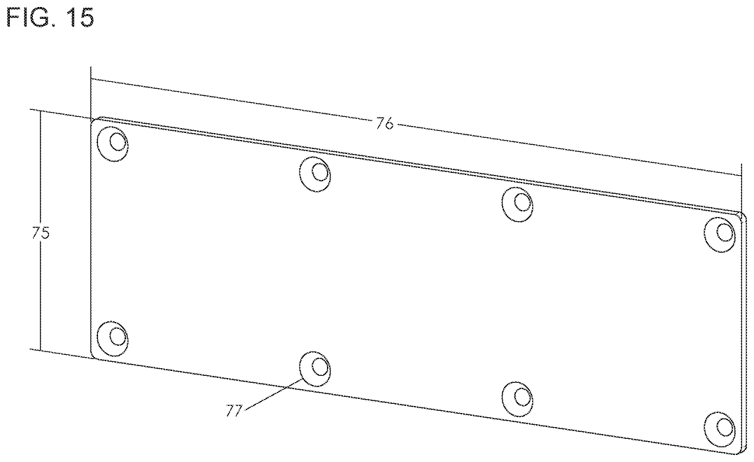

FIG. 1 illustrates the various components of one embodiment of the present disclosure. FIG. 1 represents one embodiment of the present disclosure that was constructed using the various components illustrated in FIGS. 2-16. The embodiment illustrated in. FIG. 1 shows an adaptor plate 4 attached to a top plate 3. It is preferable that the adaptor plate 4 be constructed to interchangeably connect to the top plate 3. At least one alignment pin 13 properly positions the adaptor plate 4 on the top plate 3. In this embodiment, the at least one alignment pin 13 is installed permanently into the channel plate 7 and is located both on top plate 3 and adaptor plate 4, simultaneously. The top plate 3, adaptor plate 4, and channel plate 7 are secured together using threaded knobs 11. In this embodiment, a heating plate assembly 9 also has threaded knobs 11 installed into the channel plate 7. The knobs 11 on both the adaptor plate 4 and the heating plate assembly 9 are installed into the channel plate 7 through the top plate 3.

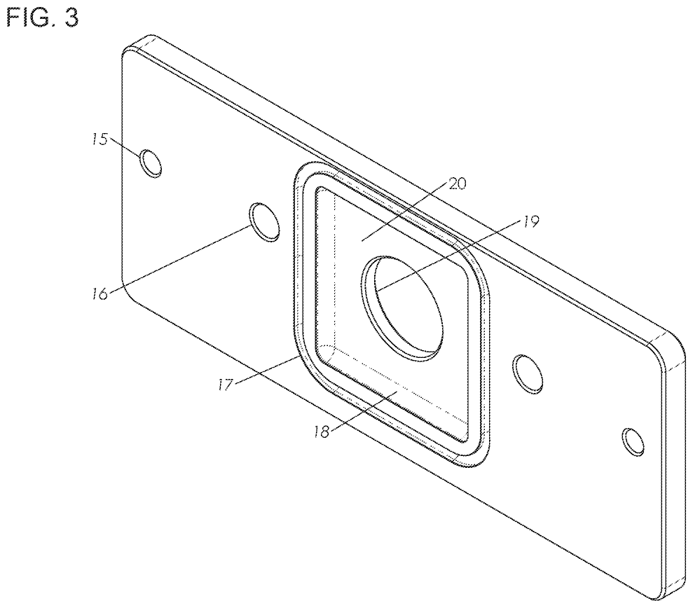

In this embodiment, now referring to the combination of FIG. 1 and FIG. 3, it is desirable that the conjunction of clearance hole positions 15 for threaded knobs 11 and clearance hole positions 16 for alignment pins 13 prevent all incorrect assembly possibilities when all threaded knobs 11 are installed. As shown in FIG. 2, it is also desirable to use an O-ring 14 between the top plate 3 and the adaptor plate 4 in order to prevent liquid chocolate-like mass from escaping between top plate 3 and adaptor plate 4. Also shown in FIG. 1.0 2 is an in-line filter 6, which may be removed or installed by end users of the device, as needed. In other words, in this embodiment, the in-line filter 8 is removable and not required for use of the device. Turning back to FIG. 3, the coupling or nozzle input orifice 19 is the part of the device constructed to attach to the output nozzle of an OEM tempering.

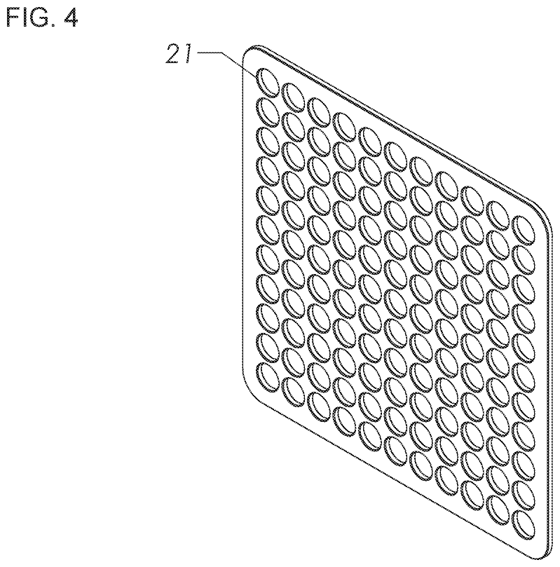

machine or other machines having output nozzles. As shown in FIG. 4, the primary top feature of the top plate 3 is an open cross-sectional area 21 with uniform diameters, which may vary depending on the embodiment.

Referring now to the combination of FIGS. 3, 4, 5, 8, 9, and 10, when a device constructed according to the present disclosure is properly attached to the output nozzle of an OEM tempering machine, liquid chocolate-like mass continuously flows through the nozzle input orifice 19, the adaptor plate filter cavity 18, the open cross-sectional area 21 of the top plate 3, the top plate output orifice 26, and. finally enters the channel plate 7 through the filter cavity of the top plate 3. Once the liquid chocolate-like mass enters the channel plate 7, it flows along the auxiliary manifold 37, the central manifold. 38, the channel 39, and exits the channel plate 7 through the plurality of channel plate output nozzles 36 on the bottom side of the channel plate 7. After exiting the channel plate output nozzles 36, the liquid chocolate-like mass flows directly into an open-faced mold having at least one mold cavity 41.

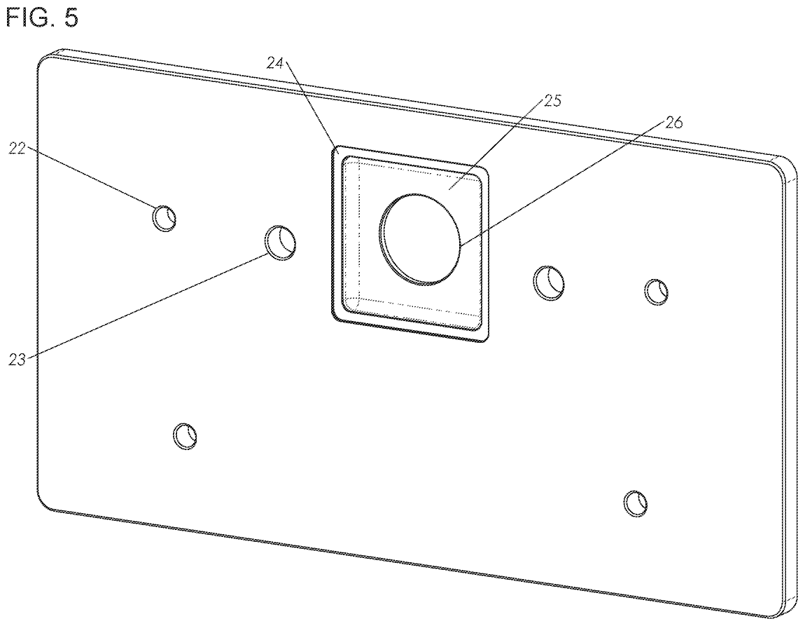

In another embodiment, and referring to the combination of FIGS. 1, 5, 8, and 12, the device has at least two channel plate output nozzles 36, and the position of the top plate output orifice 26 is in a different location than shown in FIG. 5, as specified by the end user of the device. As shown in FIG. 1, the three bar open-faced mold 2 is guided into place and supported using mold holder right 5 and mold holder left 6. The mold holder right 5 and mold holder left 6 are attached to the channel plate 7 using mold holder fasteners 12, which extend through mold position. adjustment slots 48. The mold position adjustment slots 48 allow the mold holder right 5 and the mold holder left 6 to be adjusted for proper alignment of top plate output orifice 26 to at least one mold cavity 41.

In another embodiment, and referring to the combination of FIGS. 1, 13, and 16, a heating plate assembly 9 is secured to the device using threaded knobs 11. In this embodiment, the heating plate assembly 9 provides sufficient heat power to maintain the temperature of the various components of the device at or above the melting point of chocolate-like mass. Additionally, the heating plate assembly 9 provides enough heat power to melt any amount of chocolate-like mass that has cooled to the point of solidification and trapped in the cavities, channels, or manifolds of the present device. In most embodiments, the remelting of any such. solidified chocolate will take at most thirty (30) minutes. In this embodiment, the heating plate assembly 9 employs use of a power supply independent of the OEM tempering machine. The type of independent power supply to be utilized would be readily apparent to one of ordinary skill in the art after inspection of the present disclosure. However, other embodiments of the present disclosure may use the power supply of the OEM tempering machine.

In this embodiment, and still referring to the combination of FIGS. 1, 13, and 16, the heating plate assembly 9 uses heating elements 56, which may or may not be thermostatically controlled and may require different voltages, depending on the embodiment (e.g. 12V, 24V, 48V, etc.). In this embodiment, the heating elements 56 are positive temperature coefficient heating elements. In other embodiments, the heating plate assembly 9 may use alternate heating elements, including, but not limited to, resistive heating elements. The illustrated embodiment of the present disclosure also uses an adjustable, thermostatic power supply 84. The illustrated embodiment of the current disclosure has a thermocouple 65 integrated into the heating plate assembly 9, and the thermocouple 65 measures the temperature of the heating plate assembly 9. However, other embodiments of the present disclosure may use alternate temperature measurement instruments. This embodiment also uses water or liquid resistant connections and wires.

FIG. 3 illustrates one embodiment of the adaptor plate 4. The adaptor plate 4 is the part of the present disclosure that may be designed to couple or attach to an OEM output nozzle. In order to be advantageous to any end user of the device, the adaptor plate 4 may preferably be designed to conform to multiple OEM output nozzle geometries and allow the other components of the device to function seamlessly with such interchangeability. In this embodiment, the adaptor plate 4 has screw clearance hole 15 for securing or attaching the adapter plate 4 to the device. The tightening of the screws compresses O-ring 14, shown in FIG. 2, that is seated in an O-ring groove 17 on the adaptor plate 4. In a preferred embodiment, the O-ring groove 17 is one eighth (⅛) of an inch (″) thick. In order to prevent the adaptor plate 4 from being installed on the device incorrectly, the adaptor plate 4 further comprises alignment pin clearance holes 16. In this embodiment, the positioning of alignment pin clearance holes 16 is not symmetric. If the alignment pin clearance holes 16 were positioned symmetrically on the adaptor plate 4, they would not prevent incorrect assembly of the device. As shown in FIG. 1, the non-symmetric positioning of the alignment pins 13 is greater than half of the nominal screw diameter of the screw clearance holes 15 because tills conjunction of alignment pin clearance holes 16 and screw clearance holes 15 at least prevents the adapter plate 4 from being installed one hundred eighty (180) degrees out of alignment when the threaded knobs 11 are installed. In another embodiment, the adaptor plate may use only one alignment pin clearance hole to prevent misalignment.

In this embodiment, and referring now to FIG. 3 in combination with FIG. 2, the adaptor plate 4 includes an adaptor plate filter cavity 18. The adaptor plate filter cavity 18 is designed in conjunction with the in-line filter 8 and the top plate 3. The in-line filter 8 inherently reduces the open cross-sectional area of the OEM coupling or nozzle input orifice 19 if the filter 8 is placed directly in line with the orifice 19. Additionally, because filters are designed to catch debris, it can be assumed that parts of the filter will catch foreign object debris (“FOD”), and the fluid will need to flow through other open filter passageways. In order to mitigate any reduction of flow due to the introduction of the filter 8, the fluid must flow through an orifice with a greater cross-sectional area than the OEM coupling or nozzle input orifice 19. Accordingly, the cross-sectional flow area of the adaptor plate filter cavity 18 is greater than four times (“4×”) the cross-sectional flow area of the OEM coupling or nozzle input orifice 19.

As previously stated, in this embodiment, and still referring to FIG. 3, the adaptor plate 4 has an OEM coupling or nozzle input orifice 19. The OEM coupling or nozzle input orifice 19 shown is for use with a 1″ threaded coupling; however, any form of mechanical attachment and sealing to the adaptor plate 4 may be used, provided that it supplies the filter cavity 18 with fluid through OEM coupling or nozzle input orifice 19. Preferably, the OEM coupling or nozzle input orifice 19 is centered symmetrically in adaptor plate filter cavity 18. Additionally, OEM coupling or nozzle input orifice 19 should have a cross-sectional area that is greater than or equal to the OEM output nozzle cross-sectional flow area. Any coupling or nozzle that is installed in OEM coupling or nozzle input orifice 19 should not extend beyond the filter cavity inside face 20.

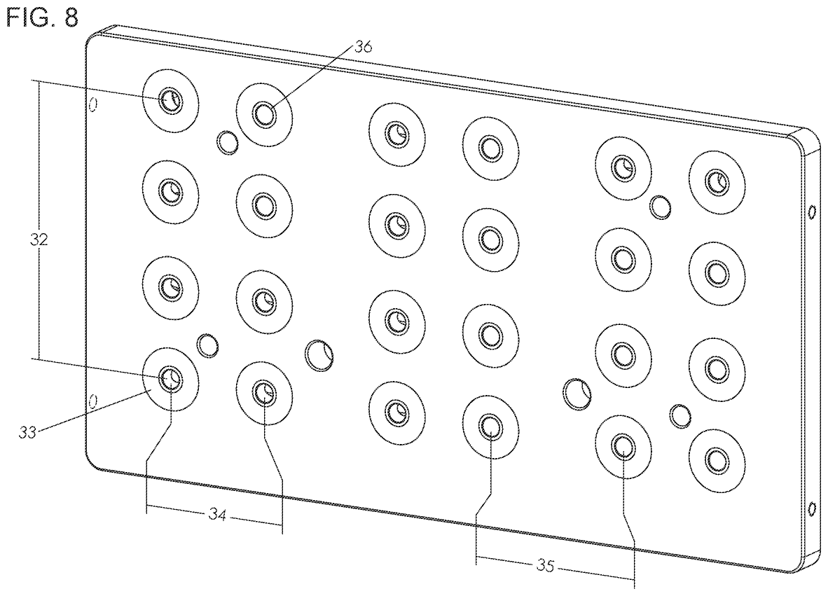

Referring now to FIG. 4 in combinations with FIGS. 1 and 2, FIG. 4 provides a perspective view of an in-line filter 8. The objective of the in-line filter 8 is to prevent FOD from entering the channel plate 7 and creating blockages that will result in non-uniform chocolate deposition. As previously described, the filter design must have an open cross-sectional area 21 that is greater than the open cross-sectional area of the OEM coupling or nozzle input orifice 19. In order to achieve this design requirement, it is necessary increase the overall combined open and closed cross-sectional area of the in-line filter 8. In this embodiment, referring specifically to FIG. 4, the open cross-sectional area 21 of the in-line filter 8 is greater than twice the cross-sectional area of the OEM coupling or nozzle input force 19. The exact diameter of the holes that form the open cross-sectional area 21 are preferably no greater than the diameter of the output nozzles 36 on the channel plate 7, as shown in FIG. 8. It is worth noting that hole size position can vary or be optimized but attention to material strength. stiffness must be maintained as open cross-sectional area 21 is increased.

Referring now to FIG. 5 in combination with FIGS. 2 and 3, it is desirable to position the in-line filter 8 between the top plate 3 and the adaptor plate 4. In this embodiment a filter seat 24 is machined into and defined by top plate 3. It is critical that the length, width, and depth (“L×W×D”) of the in-line filter 8 be less than the L×W×D of the filter seat 24. The dimensional tolerance of the filter seat 24 and the in-line filter 8 will allow the in-line filter to be installed freely by hand. Additionally, the adaptor plate filter cavity 18 shall have a L×W that is slightly smaller than the L×lD of the in-line filter 8. The combination of these features creates a pocket to capture the filter 8.

Referring now to FIGS. 1, 5, 6, and 7, FIGS. 5 and 6 provide perspective views of one embodiment of the top plate 3 disclosed herein. In this embodiment, the top plate 3 has four screw clearance holes 22 for securing or attaching the top plate 3 to the device. In this embodiment, the action of tightening the screws applies a load that forces a sealing face 27 of the top plate 3 against a sealing face 28 of the channel plate 7. The screw clearance holes 22 are offset and not symmetric in both X and Y directions. The offset is a design feature that prevents the top plate 3 from being installed 180 degrees out of alignment from the channel plate 7. The diameter of the screw clearance holes 22 would provide a standard loose fit clearance for the screws. In this embodiment, it is preferred that two alignment pin clearance holes 23 be incorporated into the design of the top plate 3.

Referring now to FIGS. 1, 2, 3, 5, 6, 7, and 9, another embodiment of the present disclosure has alternate numbers of alignment pin clearance holes 23. The positioning of alignment pin clearance holes 23 must be identical nominal geometric relations to the alignment pin clearance holes 16 of the adaptor plate 4 and alignment pin holes 30 on the channel plate 7. In this embodiment, dowel pins are used; however, it should be noted that the dowel pins of the present embodiment are used primarily to prevent incorrect assembly orientation of the various components of the device. Of course, different mechanical means of controlling assembly orientation are acceptable and well within the scope of the present disclosure. Additionally, it should be noted that no feature in the present disclosure needs alignment greater than plus or minus (+/−) 0.010″, and more often than not features can have looser tolerances for alignment, and a device constructed according to the present disclosure would still function properly. In this embodiment, the filter seat 24 is a feature which aids in the capturing of in-line filter 8. The 3( )filter seat 24 should have a L×W×D greater than the in-line filter 8. The top plate filter cavity 25 serves the same purpose as the adaptor plate filter cavity 18. Accordingly, the top plate filter cavity 25 shall have a cross-sectional flow area 4× greater than the cross-sectional flow area of the OEM coupling or nozzle input orifice 19. Top plate output orifice 26 should have a cross-sectional flow area equal to or greater than the cross-sectional flow area of the OEM coupling or nozzle input orifice 19. Preferably, in this embodiment, the top plate output orifice 26 shall be centered geometrically in the filter cavity top plate 25. The orifice 26 should be positioned so that liquid chocolate-like mass flows freely to the central manifold 38 of the channel plate

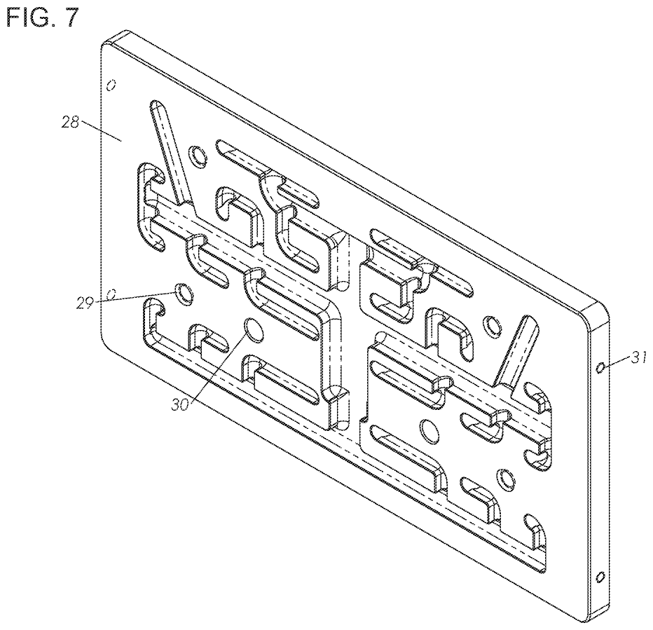

Referring now to FIGS. 1 and 7, an embodiment of the channel plate 7 is described. In this embodiment, channel plate sealing surface 26 shall have a surface finish having a roughness average (“Ra”) with a minimum of sixteen (16) micro inches (“pin”). The Ra of a surface finish is calculated by determining the maximum difference between the peaks and valleys of a particular surface. In this embodiment, the channel plate sealing surface 28 having a surface finish of at least Ra 16pin means the difference between the peaks and valleys created by the tools used to manufacture the channel plate 7 should be less than or equal to 0.000016″ (i.e., 16 μin). Typical distributions of chocolate particle sizes, published by various open sources in the art, state that the size of approximately ninety-nine percent (˜99%) of all chocolate articles in a typical batch of milk, 70% cacao or 99% cacao chocolate-like mass, is greater than 20 μin. Thus, in this embodiment, it is preferable to maintain a surface finish of Ra 16 on the channel plate sealing surface 28 because it prevents approximately 99% of chocolate or chocolate like particles from passing between surfaces on the channel plate

In another embodiment, and referring to FIGS. 1 and 7, the surface finish or the channel late sealing surface 28 and the sealing face 27 of the top plate 3 are increased to allow larger amounts of chocolate-like mass to pass between. seal faces. This may result in either leaks to external surfaces or leaks to internal surfaces, thus reducing the effectiveness of controlling the flow path of the liquid chocolate. It is not necessary to have a surface finish that prevents all particles sizes (i.e., Ra 4 μin), as the larger masses act as self-sealing mass. In other words, it is assumed that at a certain increased surface finish the self-sealing aspect of the chocolate-like mass would become ineffective. In this embodiment, the channel plate sealing surface 28 should be machine flat within 0.010″. Because of the relatively low stiffness of the material used on channel plate and op plate 3, the two pieces deflect under compression (i.e., when tightened with threaded knobs 11). This deflection forces the two faces to sit together and effectively negates the relative flatness difference of the individual components of measured in a free state. It should also be noted that material thickness has an impact on this characteristic. In other words, if the components are designed to be thicker, a tighter tolerance may be required. Additionally, the threaded holes 29 that allow the use of threaded knobs 11 must be positioned to distribute the load as uniformly as possible within the constraints of the free space available. In this embodiment, it is preferable to have a thread engagement of at least 1.5× the nominal diameter of the fastener used.

In another embodiment, and referring to FIGS. 1 and 7, stainless steel thread inserts are used to reinforce the threaded holes 29. In this embodiment, it is preferable that the length of the threaded inserts be at least 1.5× the nominal diameter of the fastener used. In other embodiments, alternate materials may be used for the threaded insert, but it is necessary to have a corrosion resistant, strong material. The use of threaded inserts will prolong the life of the threaded member, as opposed to thread forms directly in. base material. In this embodiment, it is also preferable that at least one alignment pin hole 30 be located on the channel plate 7. The at least one alignment pin hole 30 should preferably be machined as to provide an interference fit that prevents the alignment pins 13 from moving under typical working conditions. Also, in this embodiment, mold holder thread hole 31 in the channel plate 7 should be used as the internal thread for mold holder fastener 12. Preferably, stainless steel thread inserts reinforce the mold holder thread hole 31, and the length of the threaded inserts is least 1.5× the nominal diameter of the fastener 12 used.

In this embodiment, and referring to FIGS. 1, 8, and 10, a three bar open-faced mold 2 is used; however, in other embodiments, the positioning of the channel plate output nozzles 36 will depend on the specific configuration of an end users open face mold. In this embodiment, it is preferable to position of each channel plate output nozzle 36 uniformly and symmetrically along the bar width 34. It is desirable to position the centerline of each channel plate output nozzle 36 so that the channel plate output nozzles 36 are equidistance from each open-face mold edge face 40. Additionally, it is desirable to have an equal distance between each centerline of the various channel plate output nozzles 36. In this embodiment, it is desirable to have symmetric positioning of the channel plate output nozzles 36 in order produce a uniform aesthetic pattern on the exposed face of the open-face mold. Additionally, the symmetric positioning of the channel plate output nozzles 36 in this embodiment will prevent liquid chocolate-like mass from building up closer to one mold edge and overflowing. Preferably, the ideal deposition of liquid chocolate-like mass will leave a meniscus on all edges of the open-faced mold. In this embodiment, and still referring to FIGS. 1, 8, and 10, it is also preferable that the bar separation. 35 positions the patterns of channel plate output nozzles 36 and bar-width 34 uniformly. In other embodiments, bar separation 35 and bar-width 34 should be dictated by an end user's open-faced mold. Similarly, other embodiments of the present disclosure have alternate geometric configuration and at least one channel plate output nozzle 36. Additionally, it should be expressly understood that the present disclosure encompasses chocolate-like confections that require one channel plate output nozzle 36 per mold cavity 41, known as bon-bons or the like.

Referring now to FIGS. 3, 8, and 9, in this embodiment, initially liquid chocolate leaves the top plate 3 and enters the channel plate 7 on the central manifold 38. It is preferable that the central manifold 38 have a cross-sectional flow area equal to or greater than the cross-sectional flow area of the OEM coupling or nozzle input orifice 19. Preferably the central manifold 38 supplies any number of auxiliary manifolds 37. Preferably, any auxiliary manifold 37 may terminate at an alternate auxiliary manifold 37 or terminate at any number of channels 39. Preferably, the channels 39 terminate at a channel plate output nozzle 36. In most embodiments, the size of each manifold is dictated by the total cross-sectional flow area of the total channel plate output nozzles 36 that the manifold supplies. In this embodiment, for example, the cross-sectional flow area of the auxiliary manifold. 37 is not equal to or greater than the cross-sectional flow area of the channel plate output nozzles 36 that are supplied by the manifold 37.

Preferably, the total cross-sectional flow area of all channel plate output nozzles 36 is equal to or greater than the cross-sectional flow area of the OEM coupling or nozzle input orifice 19. In this embodiment, and still referring to FIGS. 3, 8, and 9, the total cross-sectional flow area of all channel plate output nozzles 36 is 13% greater than the OEM coupling or nozzle input orifice 19. It should be noted that decreasing the cross-sectional flow area below that of OEM coupling nozzle input orifice 19 will result in increased pressure in the system. Most tempering machines have pressure interlocks, and these interlocks will shut the OEM machines pumping or tempering cycle down if an over pressure occurs.

Thus, maintaining the total cross-sectional flow area of the channel plate output nozzles 16 at least 13% greater than the cross-sectional flow area of the OEM coupling nozzle input orifice 19 is critical to the present disclosure. Additionally, it is desirable to have generous corner radius along all inside corners of channel plate output nozzles 36, auxiliary manifold 37, and central manifold 38 to aid in ease of cleaning. For example, one embodiment of the present disclosure has inside corners with a nominal radius of ⅛″. Other embodiments of the present disclosure may have any size corner radius, or no corner radius at all.

Still referring to FIGS. 3, 8, and 9, the length, position, and cross-sectional area of any auxiliary manifolds 37, the central manifold 38, and any channels 39 is determined iteratively by balancing the exit velocity of each channel plate output nozzle 36. It is desirable to use software based computational fluid dynamics (“CFD”) to accurately balance the exit velocity of each channel plate output nozzles 36. Preferably, the largest difference in exit velocity should be no greater than 2-3%. The specific length and amount of bends of each channel is purposeful and deliberate, as these features allow the flow rate of each hole to be adjusted in the design phase. This embodiment represents one solution for a three bar open-faced mold. Of course, other embodiments of the present disclosure may have alternate bends, lengths, and positions to accommodate any given end users mold geometry.

In this embodiment, it is desirable to keep constant the cross-sectional flow area of each channels 39. Additionally, in most embodiments, the cross-sectional flow area should be equal to or greater than the cross-sectional flow area of the channel plate output nozzles 36. However, depending on the required position of the OEM coupling or nozzle input orifice 19, it may be necessary to adjust the cross-sectional flow area to achieve uniform exit velocity at the channel plate output nozzles 36.

In other embodiments, alternate fluid properties that convey the flow characteristics at the channel plate output nozzles 36 are used, including, but not limited to, mass flow rate and pressure. Preferably, any analytical work necessary to calculate the exit velocity should be performed using the material properties of the specific chocolate used. For example, the major and minor ranges of chocolate viscosity should be included in any such work. In this embodiment, white chocolate, semi-sweet chocolate, and 100% cocoa chocolate were modeled and used to perform the CET. Since liquid chocolate is a non-Newtonian fluid, it is necessary to model chocolate and chocolate-like fluids with a viscosity versus (vs) shear rate. Modeling viscosity vs shear rate allows varying inlet mass flow rates to be assessed during the design phase. Varying mass flow rates occur when assessing the tempered chocolate deposition devices functionality on various OEM tempering machines, as each model and brand will have a varying mass flow rate.

Additionally, in further embodiments, the static volume created by the combined cross-sectional flow areas should be minimized to avoid excess liquid chocolate and chocolate-like mass from remaining in the manifolds or channels during work pauses. The static volume of the present disclosure illustrated is less the ninety (90) milliliters (mL). Typical chocolate including but not limited to white chocolate, milk chocolate, and 100% dark chocolate has a density of approximately 1 gram per cubic centimeter (cm³). In the case of confection that takes the shape of a bar as illustrated by the three bar open-faced mold 2, the static volume is greater than i bar, but less than 2 bars. Additionally, chocolate and chocolate-like masses have a relatively low thermal conductivity ranging from 0.15 to 0.35 watts per meter-kelvin (W/mK) at 30° C., depending on the exact composition and distribution of sugars, fats, and solids, when compared with the thermal conductivity of water (i.e., 0.6 W/mK at 30° C. Minimizing the static volume of the present disclosure allows a larger percentage of chocolate masses to be in contact with the top plate 3 and channel, plate 7. This may be preferable during a work pause so that heat flows to the chocolate quickly from the heating plate assembly 9 to the top plate 3, and the channel plate 7. Accordingly, this allows the heating plate assembly 9 to heat a solidified chocolate mass that has been trapped in the device, for instance after a work pause, in a short amount of time on the order of 30 minutes.

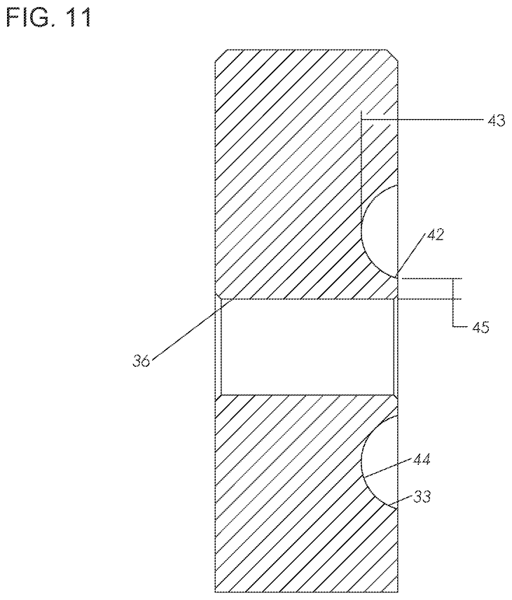

As shown in FIGS. 8 and 11, an embodiment of the present disclosure includes one nozzle anti-drip scallop 33 around each channel plate output nozzle 36 on the exit, exposed, or bottom side of the channel plate 7. In this embodiment, each nozzle anti-drip scallop 33 is concentric to its respective channel plate output nozzle 36, and each nozzle anti-drip scallop 33 is positioned with an appropriate scallop offset 45. In this embodiment, the scallop offset 45 has a nominal distance of 0.050″. Each nozzle anti-drip scallop 33 has a hemispherical radius 44 cross section that sweeps concentrically around each channel plate output nozzle 36. Additionally, in this embodiment, the hemispherical radius 44 shall has a nominal radius of ⅛″. Preferably, the scallop depth 43 should be less than one hemispherical radius 44. Furthermore, in this embodiment, the purpose of the nozzle anti-drip scallop 33 is to create a scallop steep wall 42 near the channel plate output nozzle 36. Other embodiments of this feature may have alternate cross-sectional profiles that can be used to create the anti-drip feature. In most embodiments, any geometry that creates a sufficiently steep wall that would. break the surface tension of the chocolate and prevent it from running along the bottom surface is acceptable. Similarly, all corners should either have controlled chamfers or controlled radii, but in this embodiment, edges of the nozzle anti-drip scallop 33 do not require chamfers.

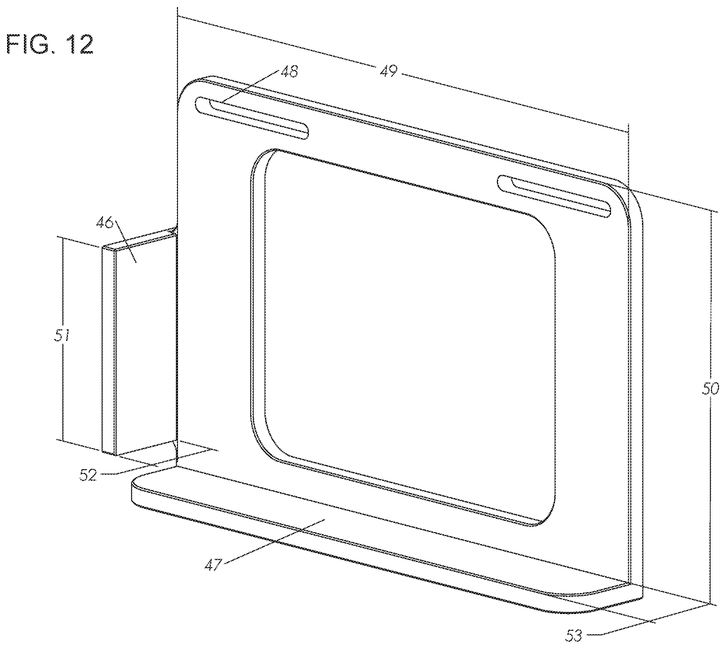

Referring now to FIGS. 1 and 12, which when combined illustrate an embodiment of the molder holder right 5 and the mold holder left 6 disclosed herein. In this embodiment, preferably mold holder depth 49 should be at least 75% of the length of the three bar open-faced mold 2 being used. In this embodiment, the mold holder depth 49 is approximately 88% the length of the three bar oven-faced mold 2. Preferably, the mold holder height 50 dictates the position of the three bar open-faced mold 2 with respect to the bottom surface 54. Additionally, in this embodiment, the mold holder height 50 provides a gap between the open-face mold top surface 10 and the bottom surface of not less than ⅛″ normally. In this embodiment, the mold slide rails 47 provide a smooth continuous surface for the three bar open-faced mold 2 to ride along. The mold end stop 46 provides a positive stopping position for the three bar omen-faced mold 2. Both the mold holder height 50 and the mold end stop height 51 can vary based on the requirements of the end user. Preferably, the mold end stop width 52 is equal to the mold slide rail width 53. The mold position adjustment slots 48 control the relative position of the mold end stop 46. The mold position adjustment slots 48 allow for varying sizes of three bar open-faced molds 2.

In this embodiment, and still referring to FIGS. 1 and 12, the mold holder right 5 and mold holder left 6 are secured to the channel plate 7 though these slots 48. Preferably, the mold holder right 5 and mold holder left 6 are secured to channel plate 7 using thread locking fasteners to secure. Another embodiment could use any type of fastener. The mold slide rail width 53 should be wide enough so that a wide range of open-faced mold sizes and geometries may be used. Accordingly, the major or constraint on the maximum mold slide rail width 53 is the proximity of mold slide rail width 53 to the channel plate output nozzle 36. Preferably, the mold slide rail width. 53 should never be wide enough to be directly under the channel plate output nozzle 36. Other embodiments may incorporate a threaded fastener or alternate mechanical feature that allows the positions of an open-faced mold 2 to be adjusted along the mold s side rail width 53 axis.

Furthermore, in this embodiment, all corners should either have controlled chamfers or controlled radii. However, the mold slide rails 47 should have a sharp inside corner at the junction of the wall.

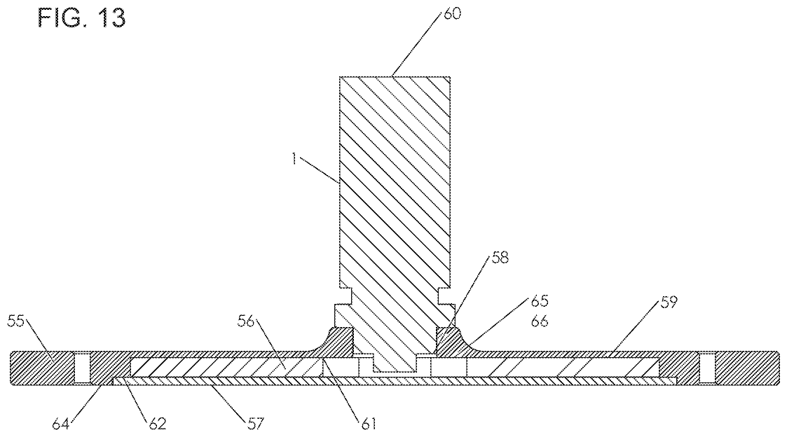

Referring now to FIGS. 1 and 13, which provide a perspective view of one embodiment of a heating plate 9 according to the present disclosure. In this embodiment, the heating plate assembly 9 consists of a heating plate body 55, which has at least one, but preferably two, heating elements 56. In one embodiment, the heating element 56 is a 24v

Positive Temperature Coefficient heater, known as “PTC” heater, and, in this embodiment, two PTC heaters connect in electrical series to a feed-through connector 1. Preferably, the feed-through connector I a water and chemical resistant, two-piece, quick connector. In this embodiment, thermally conductive paste 59 is applied between the heating elements 56 and heating plate body. 55 faces. Preferably, the step of applying the thermally conductive paste 59 performed prior to securing the heating elements 56 to the heating plate body 55 using temperature resistant adhesive 61.

All electrical connections are then insulated and soldered. Different forms of electrical connections may be used without straying from the scope of the present disclosure. In this embodiment, a heating-element cover plate 57 is fastened to the heating plate body 55 using eight heating element cover plate fasteners. Preferably, all heating element cover plate fasteners are flush or below the mounting surface 64. Preferably, thermally conductive paste 59 is applied between. the heating elements 56 and the heating element cover plate 57 surfaces. Preferably, temperature resistant sealant 62 is applied between the heating plate body 55 and the heating element cover plate 57. Preferably, temperature resistant sealant 62 is applied across the junction 58 of heating plate body 55 and the feed-through connector 1.

In this embodiment, and still referring to FIGS. 1 and 13, the heating plate assembly 9 comprises a thermocouple mounted at a thermocouple mounting location 66 using temperature resistant adhesive 61 so secure it in place. The thermocouple 65 is preferably soldered to the feed-through connector 1. Preferably, the heating plate assembly 9 also comprises a water and chemical resistant cable 60 within the feed-through connector 1. The cable 60 carries all required power for heating elements 56 and signals from the thermocouple 65. In this embodiment, it is important that the cavity that houses the heating elements 56 and thermocouple 65 is sealed from liquids, particularly, chocolate and chocolate-like mass. In this embodiment, the device conducts heat from the heating elements 56 to the heating element cover plate 57 and heating plate body 55, simultaneously, as efficiently as possible, and, in turn, effectively conducts heat to the top plate 3. It is desirable that the heating element cover plate and the heating plate body 55 surface that comprise the mounting surface 64 are co-planer to promote heat conduction to top plate 3.

In other embodiments, the heating plate assembly 9 foregoes a heating element cover plate 57 and all associated features. In these other embodiments, temperature resistant food safe epoxy is used in place of the heating element cover plate 57 to seal and secure the heating elements 56. The epoxy is poured into the cavity created for the heating elements 56 and the thermocouple 65 until it reaches the mounting surface 64, where the epoxy is then allowed to cure. In other embodiments, the heating plate assembly 9 uses a Resistance Temperature Detector (“RTD”) in place of a thermocouple; however, various types of temperature measurement instruments are well within t scope of the present disclosure. Similarly, other embodiments of the beating plate assembly 9 use a resistive heating element, and any form of heating element may be used as well.

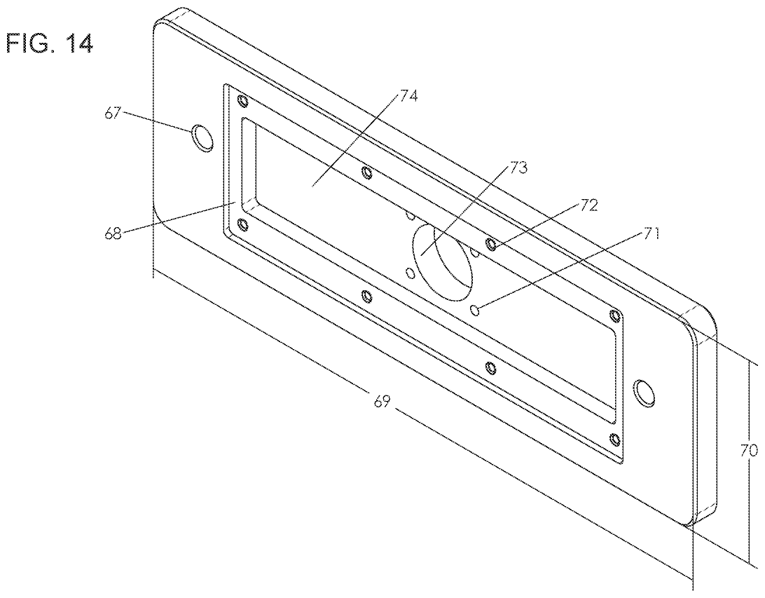

Referring now to FIGS. 13 and 14, which provide two perspective views of one embodiment of the heating plate body 55 disclosed herein. In this preferred embodiment, heating plate body 55 has two mounting screw clearance holes 67. The positions of the mounting screw clearance holes 67 should nominally be identical the threaded holes 29 of the channel plate 7, shown in FIG. 7, and the screw clearance holes 22, shown in FIG. 5. Referring to FIGS. 13 and 14, the preferred embodiment of the heating plate body 55 allows the body 55 to be mounted directly onto the top plate 3, shown in FIG. 1, with out adding additional features. In this embodiment, the heating plate body 55 has a heating element cavity 74. Preferably, the heating element cavity 74 has sufficient space to fit the heating elements 56 plus all wiring connections without preventing the heating element cover plate 57 from sitting flush on the cover plate seat 68. In this preferred embodiment, the cover plate seat 68 has a depth equal to or greater than the height of the heating element cover plate 57. The depth of the cover plate seat 68 should also take into consideration the additional thickness created from the temperature resistant sealant 62. It is desirable to control the depth of cover plate seat 68 so that heating plate body 55 and heating element cover plate 57 may create a uniform and flush mounting surface 64. Preferably, eight cover plate fastener holes 72 are used for threaded fasteners to secure the heating element cover plate 57 to the heating plate body 55.

In one embodiment, the cover plate fastener holes 72 define internal threads formed directly in the heating plate body 55. In other embodiments, the cover plate fastener holes 72 may comprise stainless steel threaded inserts. Preferably, all thread forms have enough threads to engage 1.5× the nominal diameter of any given fastener's threads. The preferred embodiment, shown in FIGS. 13 and 14, comprises a heating plate body width 69 that is nominally equal to the width of the adaptor plate 4, shown in FIG. 1. Preferably, the heating plate body length 70 nominally prevents an overlapping of the heating plate body 55 on the top plate 3, also shown in FIG. 1. Preferably, the heating plate body 55 comprises four feed through fasteners holes 71 that are incorporated for securing the power feed-through connector 1 to the heating plate body 55. Other embodiments may use any style of mechanical fixturing to secure the feed-through connector 1 to the heating plate body 55. Preferably, the heating plate body 55 defies a feed through hole 73 to feed the wires from the feed-through connector 1 through the heating plate body 55. Preferably, all corners should have controlled chamfers or controlled radii, excluding the edges of the cover plate seat 68, heating element cavity 74, and feed through hole 73.

Referring now to FIGS. 13, 14, and 15, an embodiment of the heating element cover plate 57 is illustrated. In this preferred embodiment, the heating element cover plate 57 should have a heating plate cover length 75 and a heating plate cover width 76 that allows the plate 57 to freely fit into the cover plate seat 68. In this embodiment, the fit between the cover plate seat 68 and the heating element cover plate 57 is best described as a slip fit. Preferably, the heating element cover plate 57 uses eight heating plate cover fastener counter sinks 77 nominally equally spaced. In this embodiment, the heating plate cover fastener counter sinks 77 comprise a flat head fastener, in which, the head of one of fasteners is positioned below the mounting surface 64.

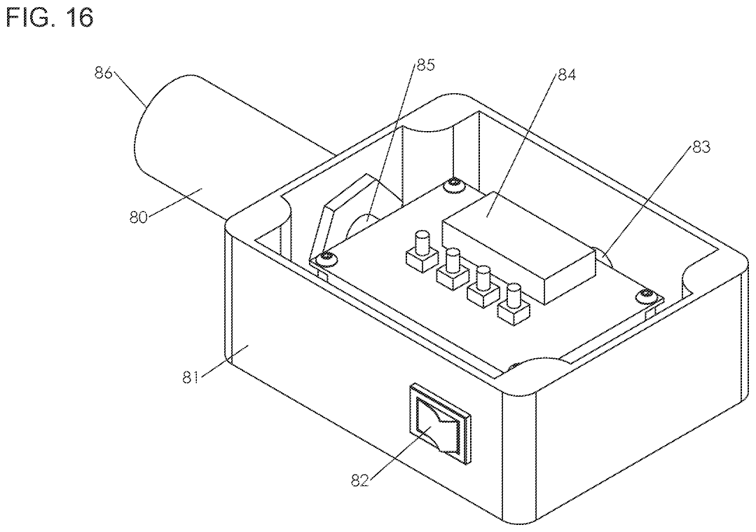

Referring now to FIGS. 13 and 16, which provide a perspective view of one embodiment of a heater controller according to the present disclosure. In this embodiment, the temperature of the heating elements 56 is controlled by the heater controller shown in FIG. 16. A suitable liquid, dust, and chemical resistant enclosure 81 houses the electronics for the heater controller. Preferably, the enclosure 81 is the structure for the mounting of the liquid resistant connector 80, a 24v power input 83, and an adjustable thermostatic power supply 84 having a 24v×12-amp heater power output. In another embodiment, the adjustable thermostatic power supply 84 may enable the user to remotely adjust the temperature without physically accessing the power supply within the heater controller, and further alternate embodiments of the power supply 84 may use any combination of voltage and amperage. In this embodiment, the adjustable thermostatic power supply 84 is powered by a 24V DC power supply, but other S voltage power supplies are expressly reserved. Preferably, the adjustable thermostatic power supply 84 has an adjustable temperature setting and is powered on and off by pressing an external on or off power switch 82. Preferably, the power supply lines, and the temperature measurement lines use a liquid resistant cable 85 within the cable enclosure 86.

Preferably, the liquid resistant cable 85 and the 24v power input. 83 are quick-easy connectors and are not hardwired. In this embodiment, all electrical connections should be insulated and soldered; however, other forms of electrical connections are within the scope of present disclosure as well.

In the foregoing description, certain terms have been used for brevity, clearness, and understanding. Nb unnecessary limitations are to be implied therefrom beyond the requirement of the prior art because such terms are used for descriptive purposes and are intended to be broadly construed. Moreover, the description and illustration of the invention is an example, and the invention is not limited to the exact details shown or described. Throughout the description and claims of this specification the words “comprise” and “include” as well as variations of those words, such as “comprises,” “includes,” “comprsing,” and “including” are not intended to exclude additives, components, integers, or steps. Additionally, in the description and claims of this specification the words “chocolate”, “liquid chocolate”, “chocolate-like” and “chocolate-like mass” and any of their variations are not. intended exclude the present invention from any liquid, material, or substance. Additionally, in the description and claims of this specification the word. “open-face mold” and its variations are not intended to exclude the present invention from any substrate for the purpose of deposition. Additionally, in the description and claims of this specification the reference to “three bar open-face mold”, “three bar mold” and any of its variations is not intended to constrain the present invention to a specific number of cavities for deposition of liquid chocolate. Additionally, in the description and claims of this specification the reference to “tempered chocolate” is not intended to exclude the present invention from deposition of non-tempered chocolate. Additionally, in the description and claims of this specification the reference to “OEM tempering machines”, “tempering machines” “tempering machine ODMS” and any variations are not intended to constrain the present inventions to those specific machines or machine types.

While several variations of the present disclosure have been illustrated by way of example in preferred or particular embodiments, is apparent that further embodiments could be developed within the spirit and scope of the present disclosure, or the inventive concept thereof. However, it is to be expressly understood that elements described in one embodiment may be incorporated with any other embodiment in combination with any other elements disclosed herein in the various embodiments. It is also to be expressly understood that any modifications and adaptations to the present disclosure are within the spirit and scope of the present disclosure, and are inclusive, but not limited to the following appended claims as set forth.

What is claimed is:

1. A liquid deposition device comprising:
an adaptor plate, a top plate, and a channel plate, wherein the channel plate is connected and supported by a mold holder right and a mold holder left;
wherein a first threaded knob secures both the adaptor plate to the top plate, and the top plate on a sealing face of the channel plate; and
wherein the adaptor plate defines an input orifice, and the top plate defines an output orifice.

2. The liquid deposition device of claim further comprising a heating plate assembly, wherein a second threaded knob secures the heating plate assembly to the top plate.

3. The liquid deposition device of claim 2 wherein the heating plate assembly comprises a heating plate body and a feed-through connector, wherein the feed-through connector is attached to the heating plate body.

4. The liquid deposition device claim 3 further comprising two heating elements within the heating plate body, wherein the two heating elements are electrically connected within the feed-through connector.

5. The liquid deposition device of claim 3 wherein the feed-through connector further comprises a liquid resistant cable.

6. The liquid deposition device of claim 3 wherein the heating plate assembly further comprises a thermocouple mounted at a thermocouple mounting location within the heating plate body.

7. The liquid deposition device of claim further comprising a three bar open-face mold, wherein the three bar open-face mold is slideably connected to the mold holder right and the mold holder left.

8. The liquid deposition device of claim 1 wherein the channel plate further defines a central manifold on the sealing face of the channel plate.

9. The liquid deposition device of claim 1 wherein the adaptor plate defines an adaptor plate filter cavity, and the top plate defines a top plate filter cavity.

10. The liquid deposition device of claim 9 further comprising in-line filter, wherein the in-line filter is positioned between the adaptor plate filter cavity and the top plate filter cavity.

11. The liquid deposition device of claim 1 further comprising an wherein the adaptor plate defines an O-ring groove, and the O-ring sits in the O-ring groove of the adaptor plate.

12. The liquid deposition device of claim 1 wherein the channel plate defines a first mold holder thread hole and a second mold holder thread hole.

13. The liquid deposition device of claim 12 wherein the mold holder right is secured to the first mold holder thread hole by a first mold holder fastener, and the mold holder left is secured to the second mold holder thread hole by a second mold holder fastener.

14. The liquid deposition device of claim 1 wherein a bottom side of the channel plate further comprises a plurality of channel plate output nozzles.

15. The liquid deposition device of claim 14 further comprising a plurality of nozzle anti-drip scallops, wherein each one of the plurality of nozzle anti-drip scallops surround each one of the plurality of channel plate output nozzles.

16. The liquid deposition device of claim 1 wherein at least one of the mold holder right or the mold holder left comprises a mold end stop, a mold position adjustment slot, and a mold slide rail.

17. A method for making and using a liquid chocolate deposition device, the liquid chocolate deposition device comprising:
an adaptor plate, a top plate, and a channel plate, wherein the channel elate is connected to and supported by a mold holder right and a mold holder left,
wherein a first threaded knob secures both the adaptor plate to the top plate, and the top plate on a sealing face of the channel plate, and
wherein the adaptor plate defines an input orifice, and the top plate defines an output orifice;
the method comprising the steps of:
providing the liquid chocolate deposition device,
loosening the first threaded knob, and removing the adaptor plate,
placing an in-line filter on a filter seat defined on a top of the top plate,
placing the adaptor plate on the top of the top plate having the in-line filter, and tightening the first threaded knob.

18. The method of claim 17, the liquid chocolate deposition device further comprising a three bar open-face mold, the mold holder right comprising a first mold slide rail, and the mold holder left comprising a second mold slide rail; the method further comprising the step of sliding the three bar open-face mold along the first and the second mold slide rails.

19. The method of claim 17 wherein the liquid chocolate deposition device further comprises a heating plate assembly, the heating plate assembly further comprising a plurality of heating elements; the method further comprising the step of controlling the temperature of the heating elements with a heater controller.

20. The method of claim 19 wherein the heater controller comprises a power switch and an adjustable thermostatic power supply; the method further comprising the steps of:
turning the heater controller on by pressing the power switch on, and
adjusting the temperature of the heating elements with the adjustable thermostatic power supply.
